(19) United States
(12) Patent Application Publication
(10) Pub. No.: US 2025/0233346 A1
(43) Pub. Date: Jul. 17, 2025

(54) Cable-end Connector and Insulation Housing Assembly Thereof

(71) Applicants: Dongguan Tarng Yu Electronics Co., Ltd., Dongguan City (CN); Tarng Yu Enterprise co., ltd., New Taipei City (TW)

(72) Inventors: TSUNG-CHI CHEN, New Taipei City (TW); MU-JUNG HUANG, New Taipei City (TW)

(21) Appl. No.: 19/017,244

(22) Filed: Jan. 10, 2025

(30) Foreign Application Priority Data
Jan. 12, 2024 (TW) 113200483

(51) Int. Cl. H01R 13/506

(52) U.S. Cl. CPC H01R 13/506

(57) ABSTRACT

A cable-end connector and insulation housing assembly thereof are provided. The cable-end connector is paired with a conductive cable, and the insulation housing assembly is capable of guiding the extension of the conductive cable so that extension direction of the conductive cable aligns with expectations. This allows the conductive cable to be easily organized within the electronic device, preventing unnecessary tangling and enabling electronic devices to continue evolving toward being thinner, lighter, and more compact. Additionally, the insulation housing assembly is formed by combining multiple housings. By adjusting the structure of the combined housings, the insulation housing assembly can guide the conductive cable to extend in the desired direction.

### CROSS-REFERENCE TO RELATED APPLICATIONS

This application claims the priority of Republic of China Patent Application No. 113200483 filed on Jan. 12, 2024, in the State Intellectual Property Office of the R.O.C., the disclosure of which is incorporated herein by reference.

### BACKGROUND OF THE INVENTION

### Field of the Invention

This application relates to a cable-end connector and insulation housing assembly thereof. More specifically, it pertains to a cable-end connector and its insulation housing assembly that can guide the extension of a paired conductive cable.

### Descriptions of the Related Art

In modern electronic devices, cable-end connectors are typically installed. Generally, a cable-end connector can be paired with a conductive cable to provide electrical signal transmission. With the ongoing trend of making electronic devices thinner, lighter, and more compact, the internal space available for cable organization in electronic devices has been significantly reduced, thus restricting the extension manner of conductive cables paired with cable-end connectors.

In light of this, how to ensure that the extension manner of a conductive cable paired with a cable-end connector meets expectations to make the conductive cable paired with a cable-end connector easier to organize within the electronic device, thereby allowing electronic devices to continue evolving toward being thinner, lighter, and more compact, has become a pressing technical issue that the industry is eager to address and overcome.

### SUMMARY OF THE INVENTION

In view of the drawbacks of the prior art mentioned above, the present application provides a cable-end connector, the cable-end connector being paired with a conductive cable, the cable-end connector comprising: a conductive terminal, the conductive terminal being connected to the conductive cable; an insulation base, the insulation base being mated with the conductive terminal, allowing the conductive terminal to extend in a terminal extension direction, the insulation base comprising a first side and a second side; a first insulation housing, the first insulation housing comprising a first housing assembly structure; and a second insulation housing, the second insulation housing comprising a second housing assembly structure; wherein the first insulation housing is located on the first side, and the second insulation housing is located on the second side, and the first housing assembly structure is assembled with the second housing assembly structure, causing the first insulation housing and the second insulation housing to form an insulation housing assembly, wherein the insulation housing assembly comprises an insulation base accommodating space, a conductive cable outlet port, and a conductive cable extension guiding structure, the insulation base accommodating space being provided to accommodate the insulation base, the conductive cable extension guiding structure being configured to guide the extension of the conductive cable, allowing the conductive cable to extend in a cable extension direction to the conductive cable outlet port, wherein the cable extension direction is substantially different from the terminal extension direction.

Preferably, the cable-end connector said above, wherein the conductive cable extension guiding structure is installed on the first insulation housing or the second insulation housing.

Preferably, the cable-end connector said above, wherein the conductive cable extension guiding structure is a plate-like structure capable of providing a guiding surface.

Preferably, the cable-end connector said above, wherein the conductive cable outlet port is installed on the second insulation housing.

Preferably, the cable-end connector said above, wherein the insulation base comprises a first base positioning structure and a second base positioning structure, the first insulation housing further comprises a first housing positioning structure, the second insulation housing further comprises a second housing positioning structure, the first base positioning structure being paired with the first housing positioning structure to position the first insulation housing on the insulation base, and the second base positioning structure being paired with the second housing positioning structure to position the second insulation housing on the insulation base.

Preferably, the cable-end connector said above, wherein the first base positioning structure and the first housing positioning structure are structurally compatible protrusion-and-recess structures, and the second base positioning structure and the second housing positioning structure are structurally compatible protrusion-and-recess structures.

Preferably, the cable-end connector said above, wherein the first housing assembly structure and the second housing assembly structure are structurally compatible fastening structures.

Preferably, the cable-end connector said above, wherein the cable extension direction is substantially orthogonal to the terminal extension direction.

Furthermore, the present application provides an insulation housing assembly, the insulation housing assembly being paired with a conductive terminal and a conductive cable, wherein the conductive terminal is connected to the conductive cable, allowing the conductive terminal and the conductive cable to form a terminal cable module, the terminal cable module comprising a first side and a second side; the insulation housing assembly comprising: a first insulation housing, the first insulation housing comprising a first housing assembly structure; and a second insulation housing, the second insulation housing comprising a second housing assembly structure; wherein: the first insulation housing is located on the first side, and the second insulation housing is located on the second side, and the first housing assembly structure is assembled with the second housing assembly structure to form a terminal cable module accommodating space, a conductive cable outlet port, and a conductive cable extension guiding structure, the terminal cable module accommodating space being configured to accommodate the terminal cable module, allowing the conductive terminal to extend in a terminal extension direction, the conductive cable extension guiding structure being configured to guide the extension of the conductive cable, allowing the conductive cable to extend in a cable extension direction to the conductive cable outlet port, wherein the cable extension direction is substantially different from the terminal extension direction.

Preferably, the insulation housing assembly said above, wherein the conductive cable extension guiding structure is installed on the first insulation housing or the second insulation housing.

Preferably, the insulation housing assembly said above, wherein the conductive cable extension guiding structure is a plate-like structure capable of providing a guiding surface.

Preferably, the insulation housing assembly said above, wherein the conductive cable outlet port is installed on the second insulation housing.

Preferably, the insulation housing assembly said above, wherein the first housing assembly structure and the second housing assembly structure are structurally compatible fastening structures.

Compared to the prior art, the present application provides a cable-end connector and insulation housing assembly thereof. The provided cable-end connector is used in paired with a conductive cable, and the insulation housing assembly can guide the extension of the conductive cable, ensuring that the extension direction of the conductive cable aligns with expectations. This facilitates easier organization of the conductive cable within the interior of electronic devices, thereby avoiding unnecessary entanglement. As a result, electronic devices can continue to evolve toward being thinner, lighter, and more compact. Furthermore, the insulation housing assembly is formed by assembling multiple housings. By adjusting the structure of the assembled housings, the insulation housing assembly can guide the conductive cable to extend in the desired direction.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a three-dimensional schematic diagram of a cable-end connector of the present application in a first point of view according to one embodiment.

FIG. 2 is a three-dimensional schematic diagram of a cable-end connector of the present application in a second point of view according to one embodiment.

FIG. 3 is a three-dimensional schematic diagram of a cable-end connector of the present application in a third point of view according to one embodiment.

FIG. 4 is a three-dimensional schematic diagram of a cable-end connector of the present application in a fourth point of view according to one embodiment.

FIG. 5 is a rear schematic diagram of a cable-end connector of the present application according to one embodiment.

FIG. 6 is a cross-sectional schematic diagram of a portion of the cable-end connector shown in FIG. 5, taken along line AA.

FIG. 7 is a three-dimensional schematic diagram of a portion of a cable-end connector of the present application in a first point of view according to one embodiment.

FIG. 8 is a three-dimensional schematic diagram of a portion of a cable-end connector of the present application in a second point of view according to one embodiment.

FIG. 9 is a three-dimensional schematic diagram of a portion of a cable-end connector of the present application in a third point of view according to one embodiment.

FIG. 10 is a three-dimensional schematic diagram of a portion of a cable-end connector of the present application in a fourth point of view according to one embodiment.

FIG. 11 is a three-dimensional schematic diagram of a portion of a cable-end connector of the present application in a first point of view according to one embodiment.

FIG. 12 is a three-dimensional schematic diagram of a portion of a cable-end connector of the present application in a second point of view according to one embodiment.

FIG. 13 is a three-dimensional schematic diagram of a portion of a cable-end connector of the present application in a third point of view according to one embodiment.

FIG. 14 is a three-dimensional schematic diagram of a portion of a cable-end connector of the present application in a fourth point of view according to one embodiment.

FIG. 15 is a three-dimensional schematic diagram of a portion of a cable-end connector of the present application in a first point of view according to one embodiment.

FIG. 16 is a three-dimensional schematic diagram of a portion of a cable-end connector of the present application in a second point of view according to one embodiment.

FIG. 17 is a three-dimensional schematic diagram of a portion of a cable-end connector of the present application in a third point of view according to one embodiment.

FIG. 18 is a three-dimensional schematic diagram of a portion of a cable-end connector of the present application in a fourth point of view according to one embodiment.

FIG. 19 is a three-dimensional schematic diagram of a cable-end connector of the present application in a first point of view according to one embodiment.

FIG. 20 is a three-dimensional schematic diagram of a cable-end connector of the present application in a second point of view according to one embodiment.

FIG. 21 is a three-dimensional schematic diagram of a cable-end connector of the present application in a third point of view according to one embodiment.

FIG. 22 is a three-dimensional schematic diagram of a cable-end connector of the present application in a fourth point of view according to one embodiment.

FIG. 23 is a rear schematic diagram of a cable-end connector of the present application according to one embodiment.

FIG. 24 is a cross-sectional schematic diagram of a portion of the cable-end connector shown in FIG. 23, taken along line BB.

FIG. 25 is a three-dimensional schematic diagram of a portion of a cable-end connector of the present application in a first point of view according to one embodiment.

FIG. 26 is a three-dimensional schematic diagram of a portion of a cable-end connector of the present application in a second point of view according to one embodiment.

FIG. 27 is a three-dimensional schematic diagram of a portion of a cable-end connector of the present application in a third point of view according to one embodiment.

FIG. 28 is a three-dimensional schematic diagram of a portion of a cable-end connector of the present application in a fourth point of view according to one embodiment.

FIG. 29 is a three-dimensional schematic diagram of a portion of a cable-end connector of the present application in a first point of view according to one embodiment.

FIG. 30 is a three-dimensional schematic diagram of a portion of a cable-end connector of the present application in a second point of view according to one embodiment.

FIG. 31 is a three-dimensional schematic diagram of a portion of a cable-end connector of the present application in a third point of view according to one embodiment.

FIG. 32 is a three-dimensional schematic diagram of a portion of a cable-end connector of the present application in a fourth point of view according to one embodiment.

FIG. 33 is a three-dimensional schematic diagram of a portion of a cable-end connector of the present application in a first point of view according to one embodiment.

FIG. 34 is a three-dimensional schematic diagram of a portion of the cable-end connector of the present application in a second point of view according to one embodiment.

FIG. 35 is a three-dimensional schematic diagram of a portion of the cable-end connector of the present application in a third point of view according to one embodiment.

FIG. 36 is a three-dimensional schematic diagram of a portion of the cable-end connector of the present application in a fourth point of view according to one embodiment.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

Furthermore, in the following embodiments, structures or components with identical or similar functions will be denoted using the same symbols, and the descriptions of identical or equivalent technical features will be omitted to make the disclosed content more concise and easier to understand.

This application provides a cable-end connector and insulation housing assembly thereof that can guide the extension of the paired conductive cable to meet expectations. This design allows the conductive cable paired with the cable-end connector to be easily organized inside electronic devices and even prevents unnecessary entanglement of the conductive cable within the device, facilitating the continued development of electronic devices toward being thinner, lighter, and more compact.

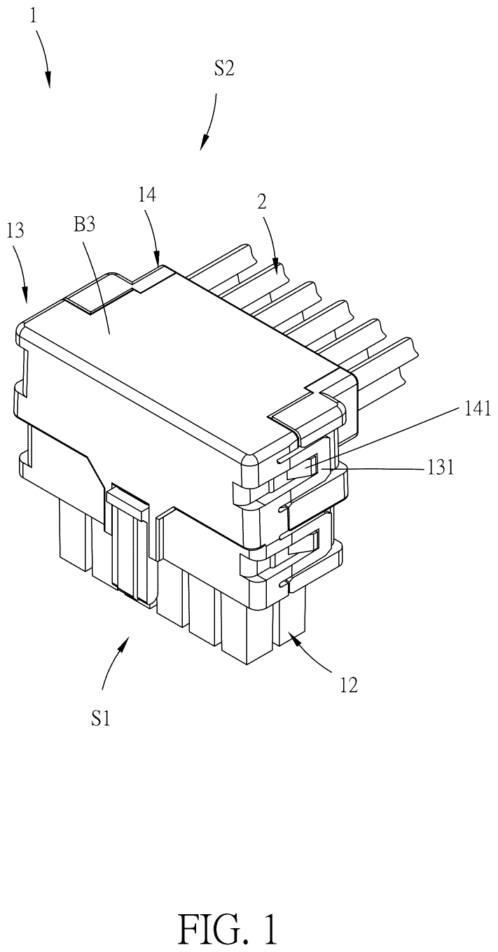

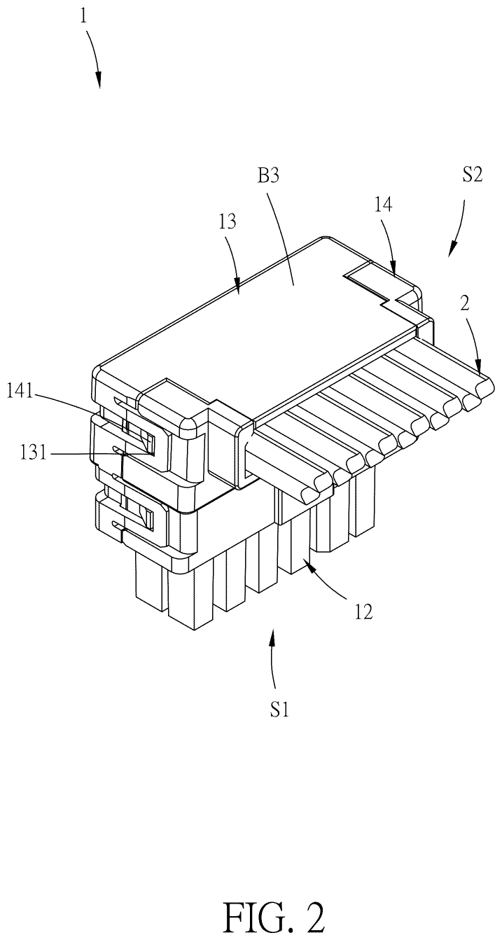

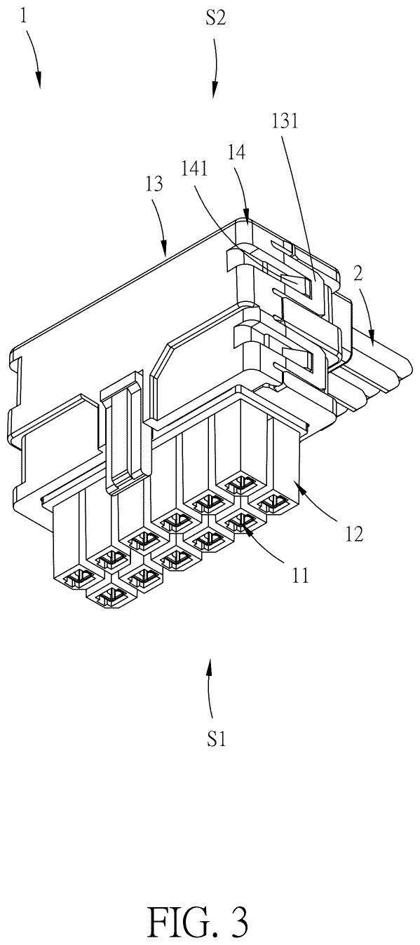

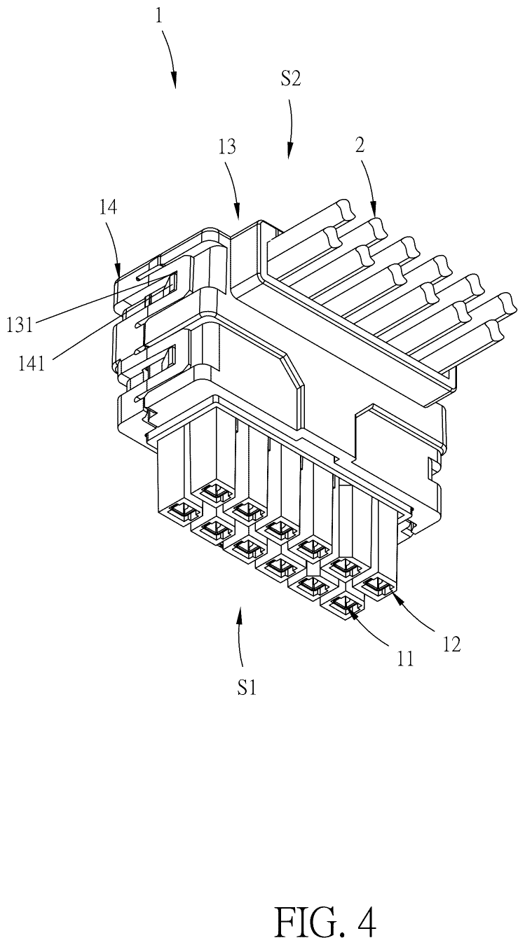

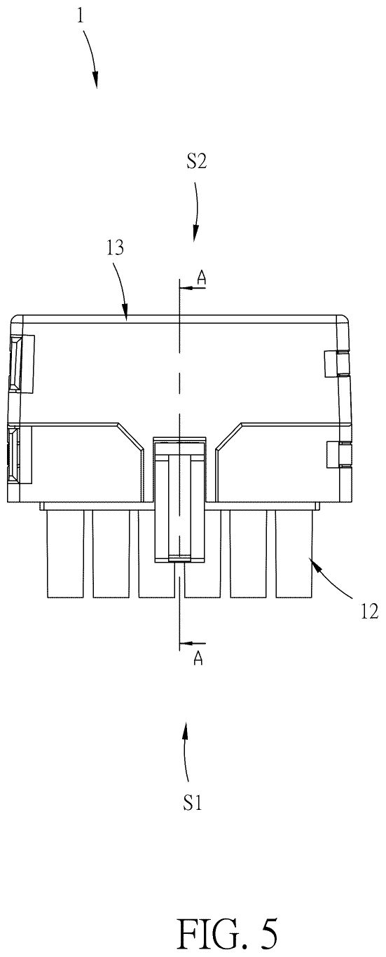

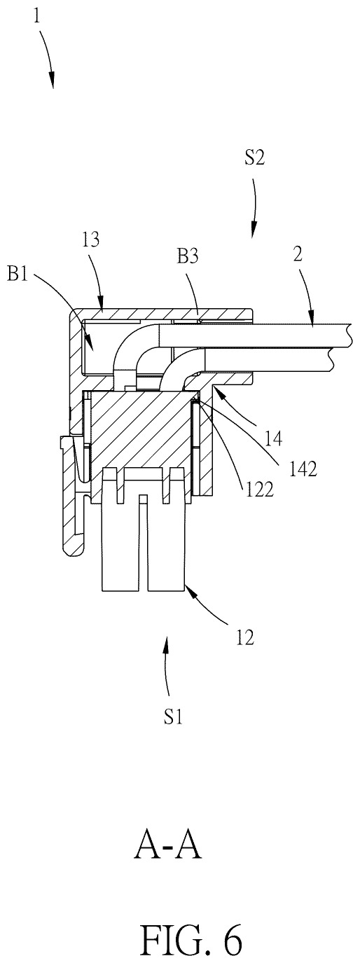

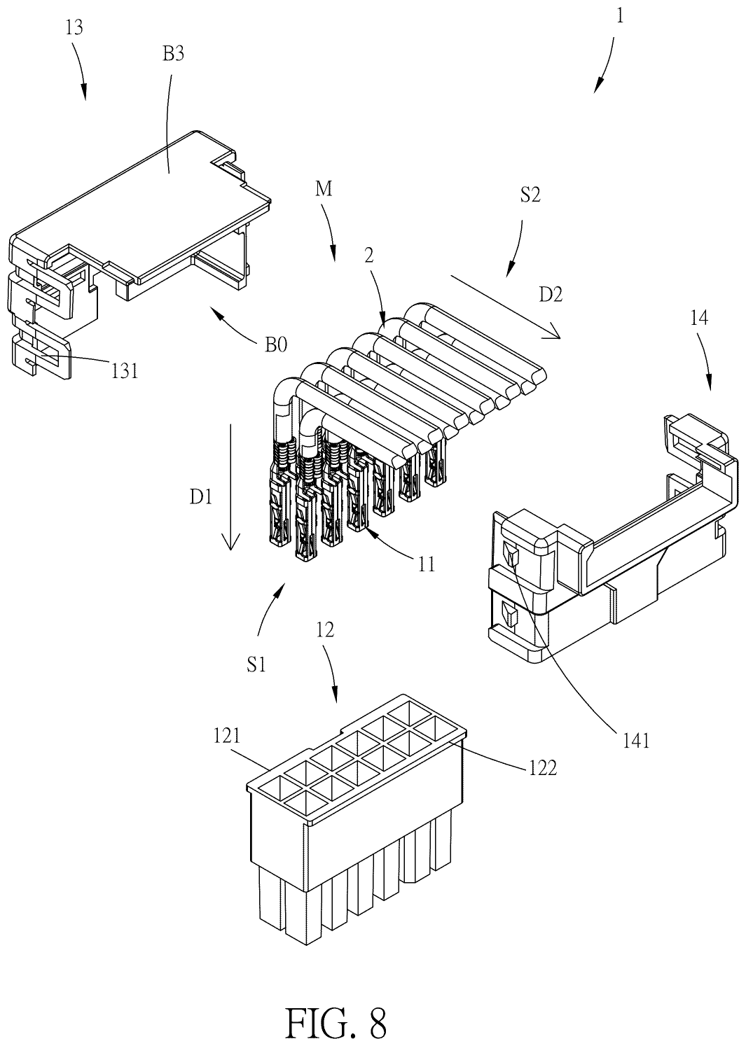

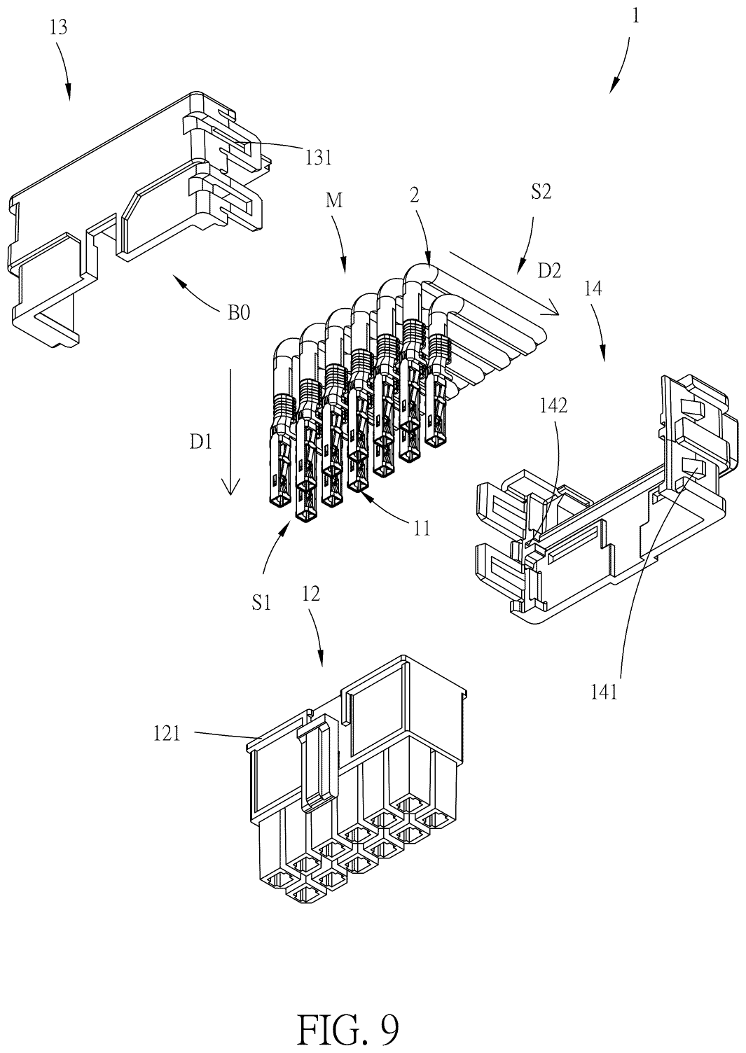

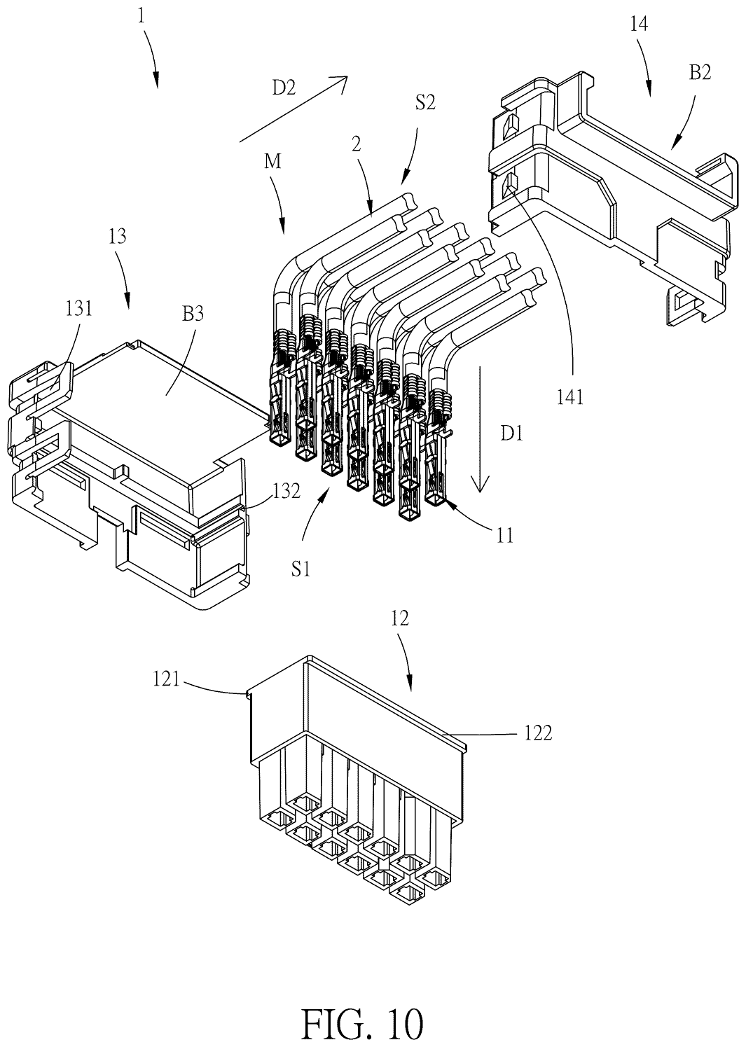

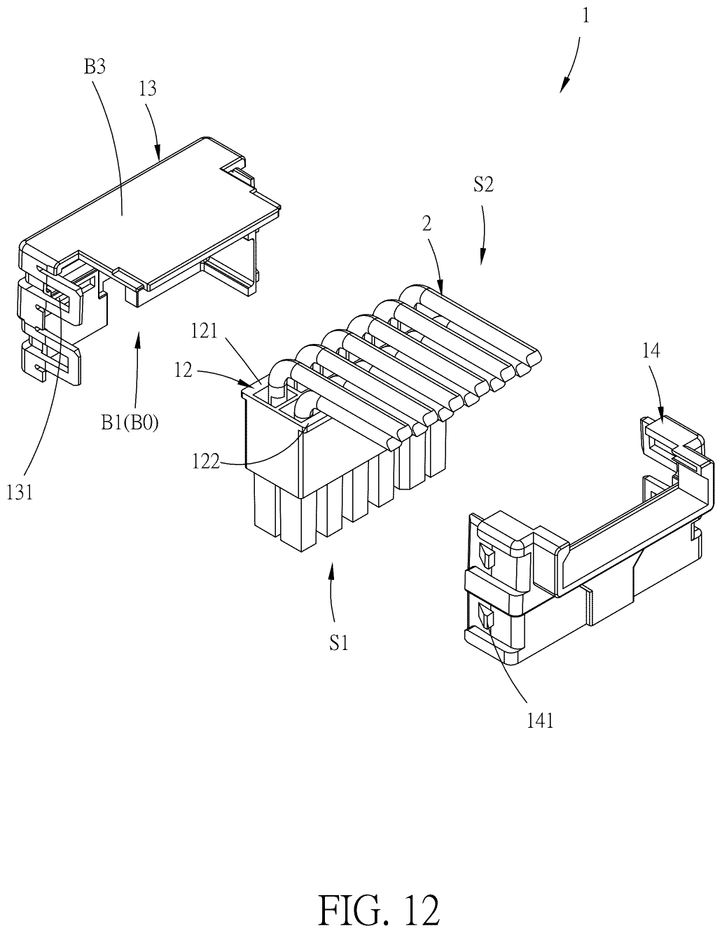

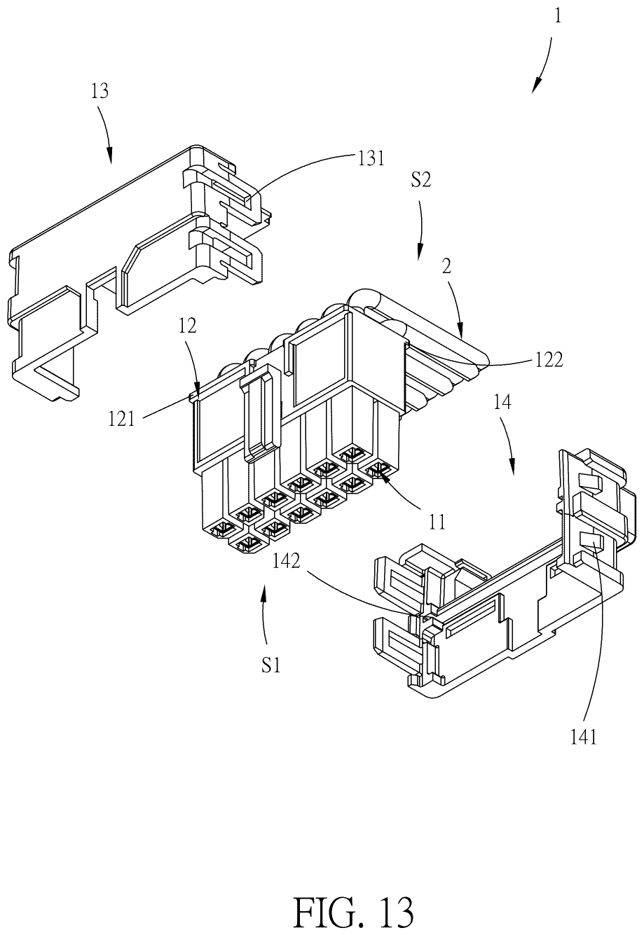

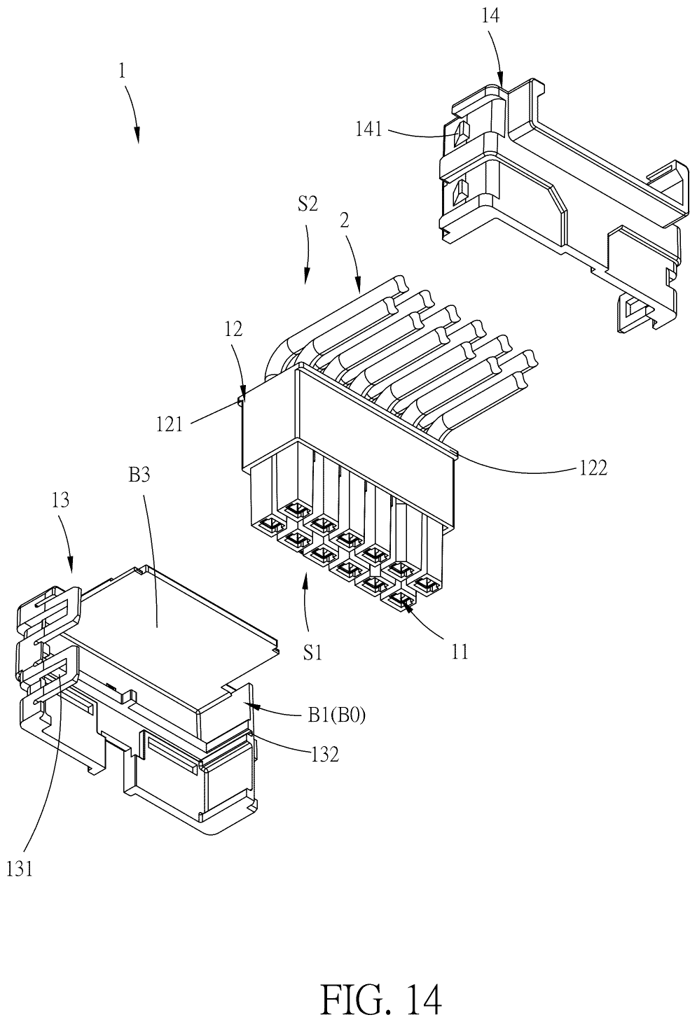

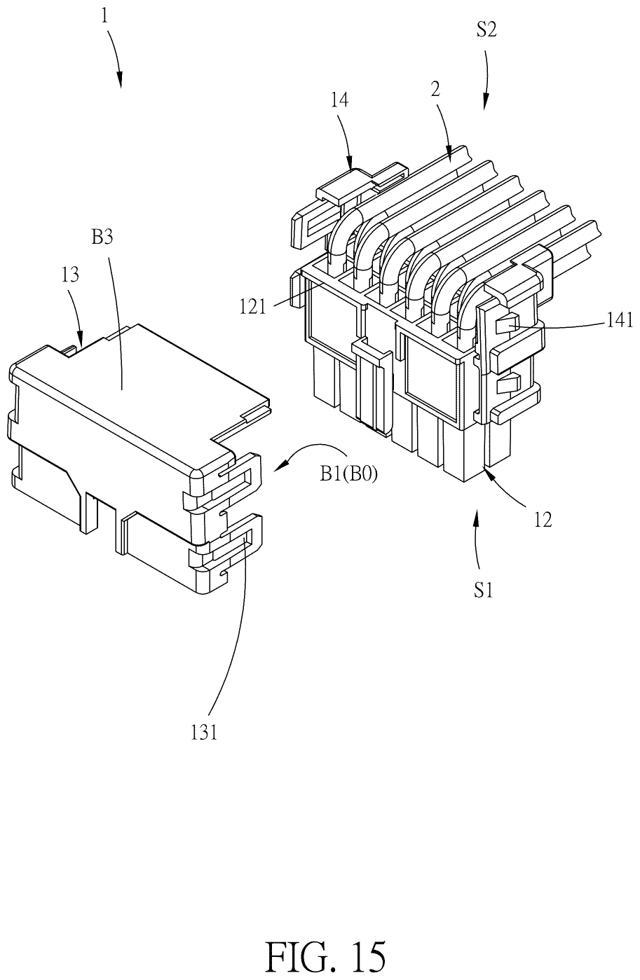

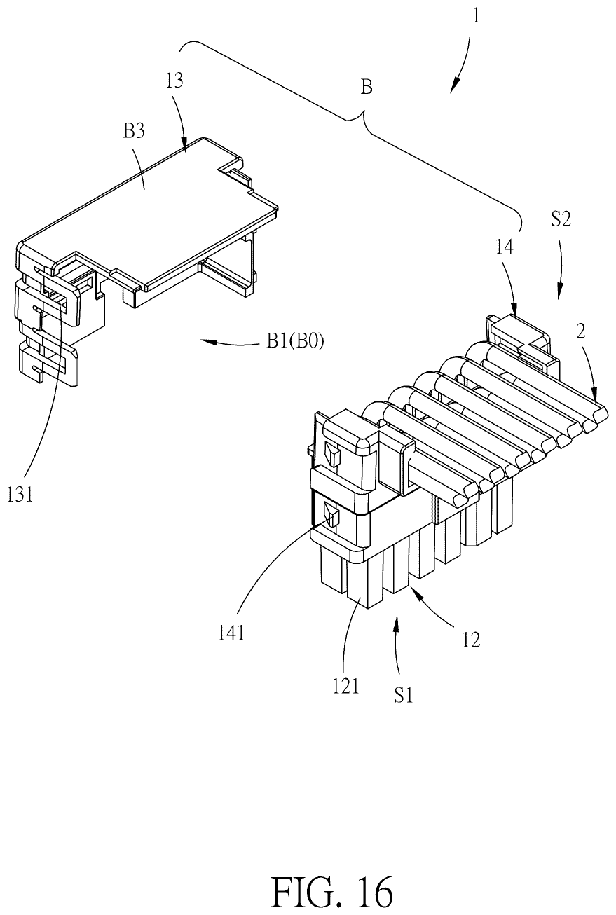

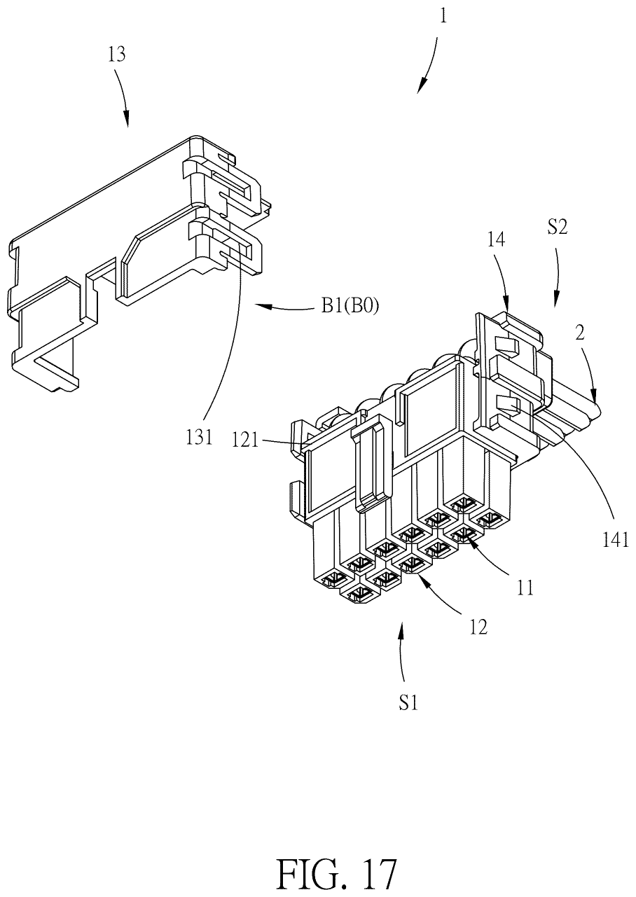

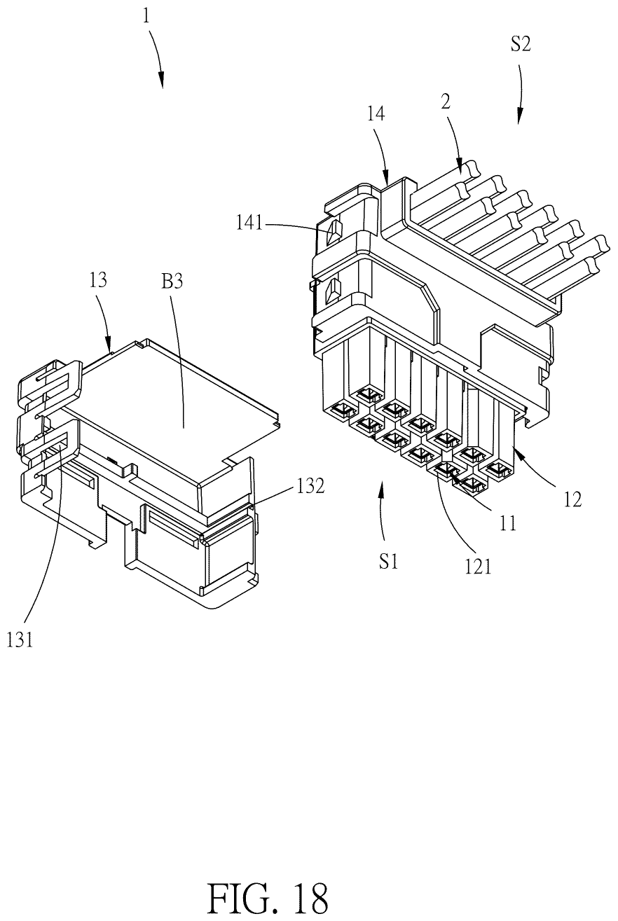

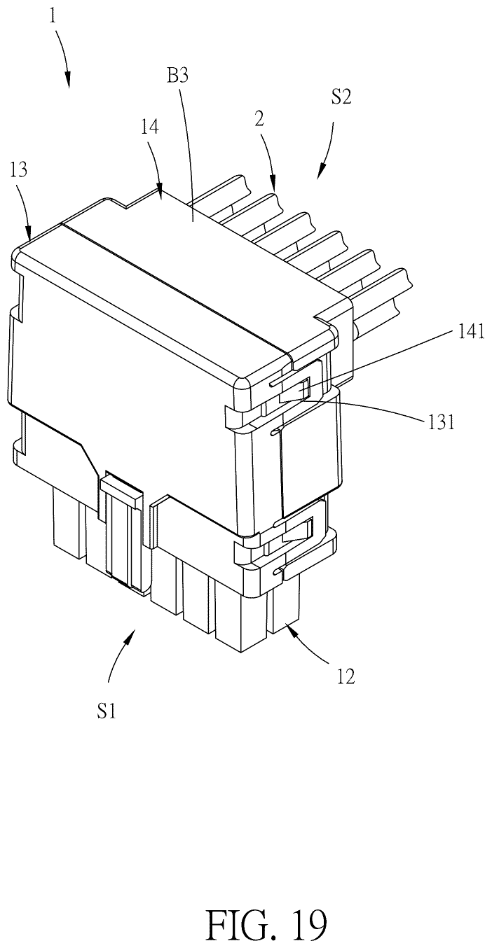

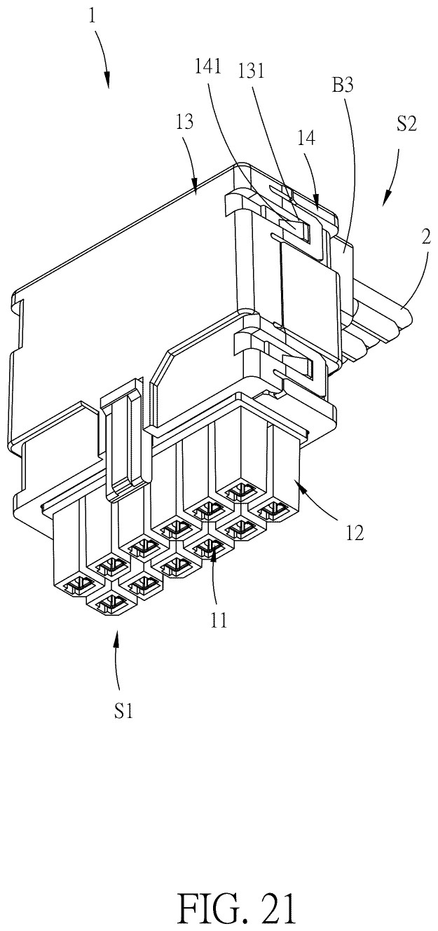

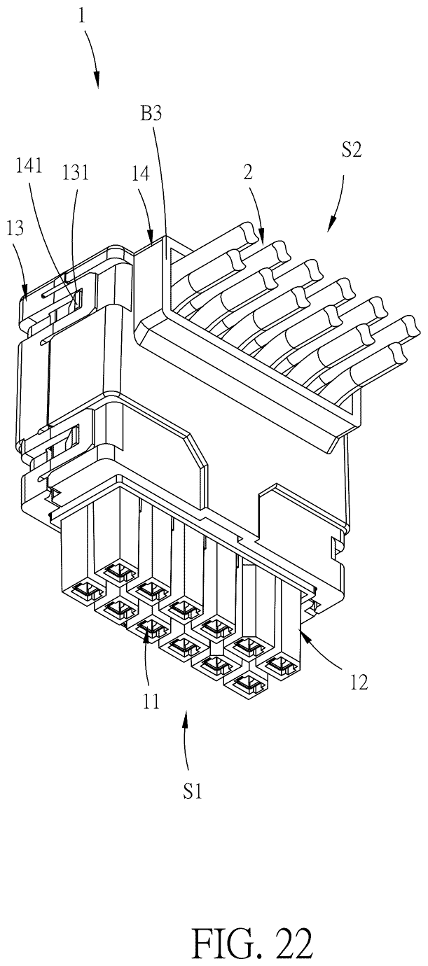

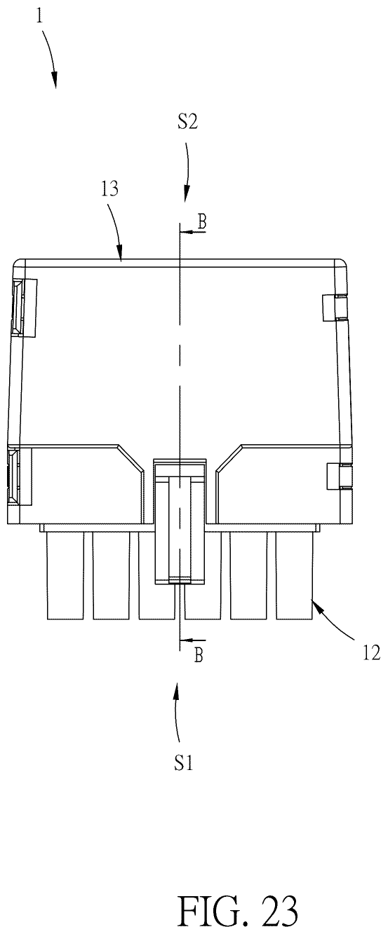

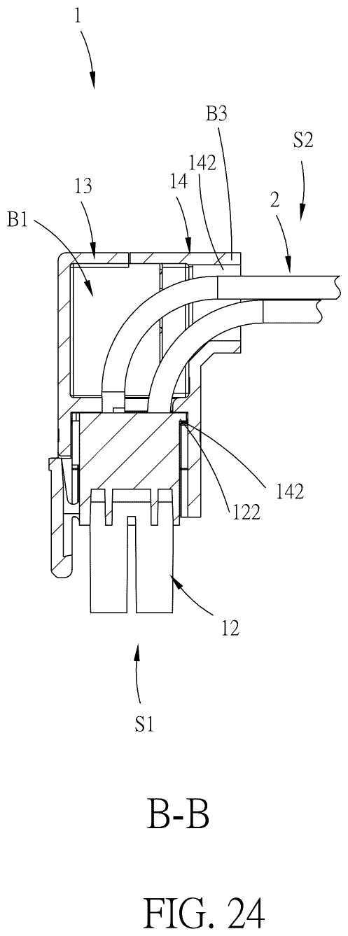

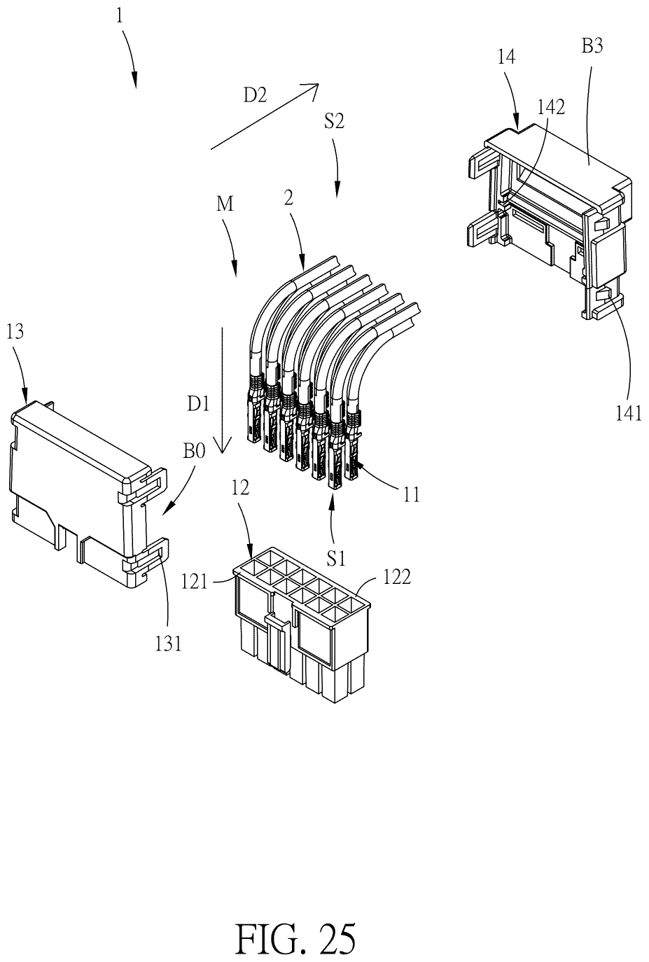

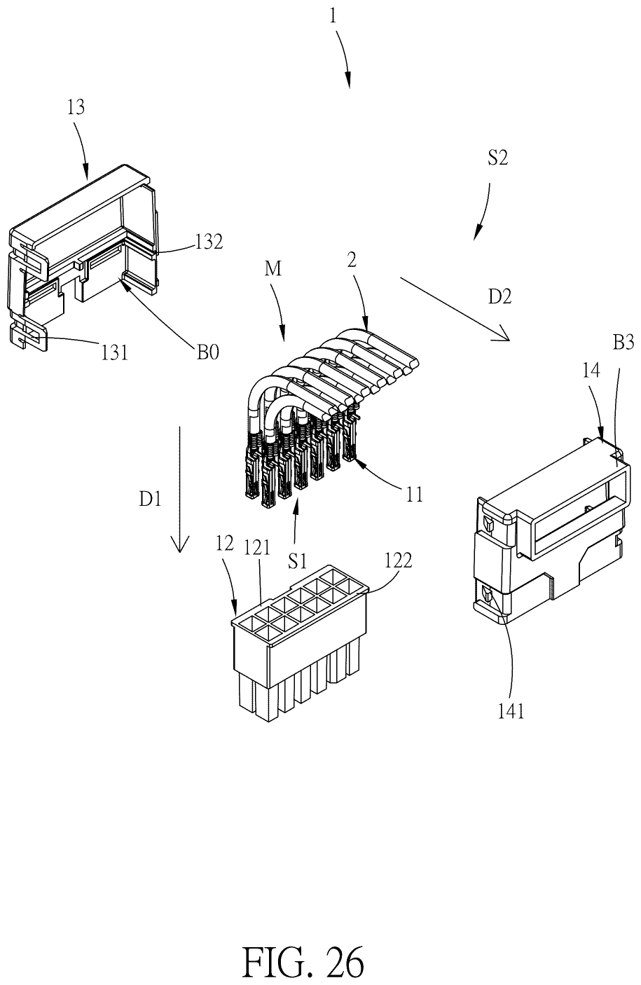

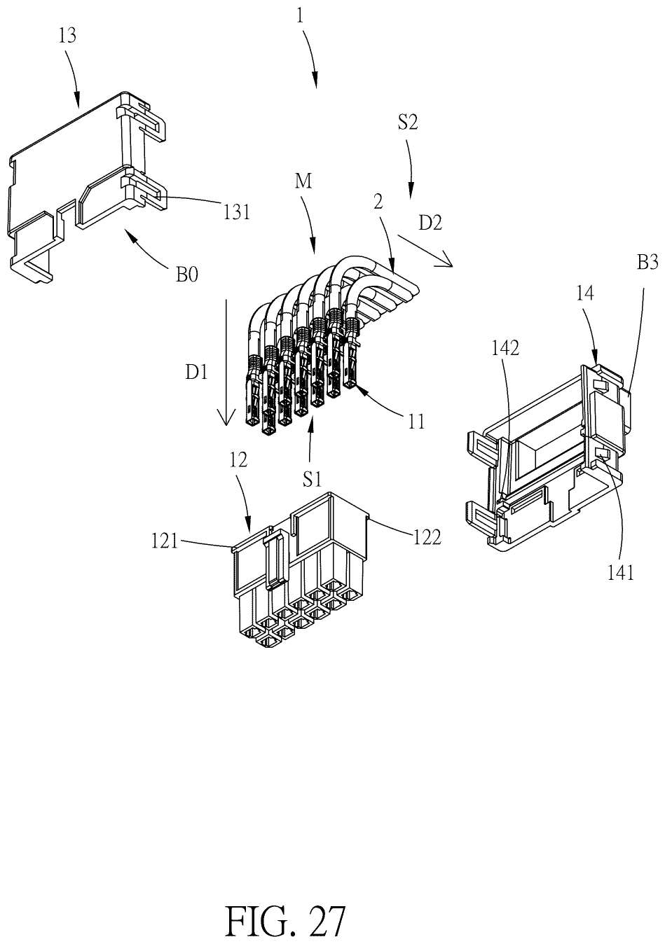

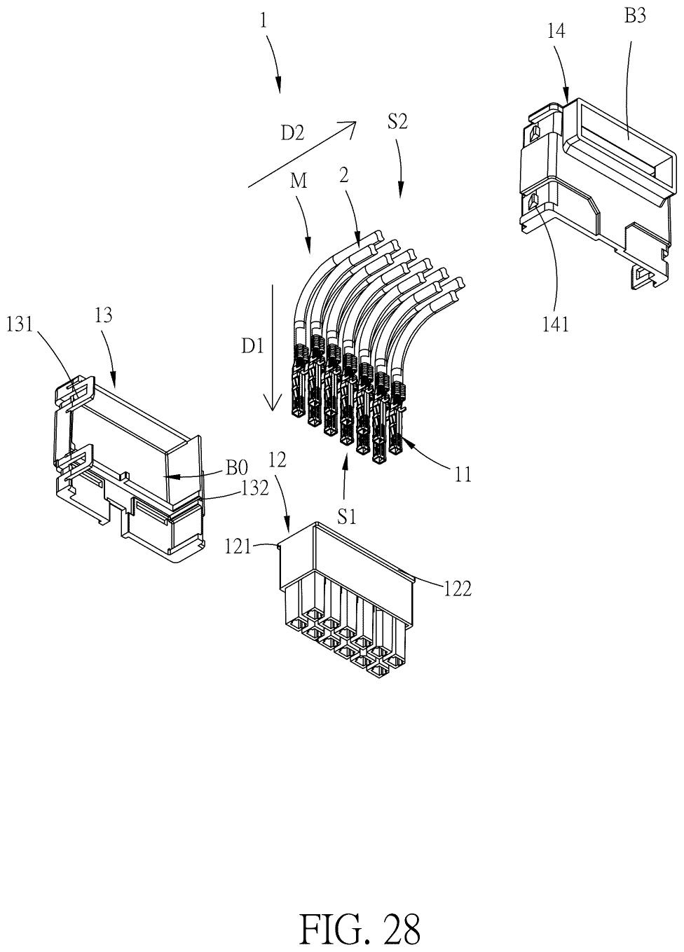

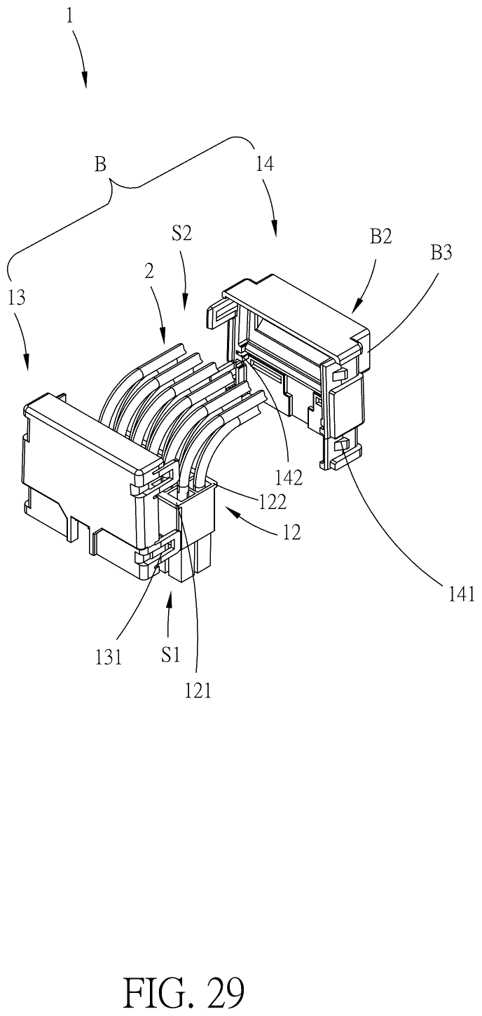

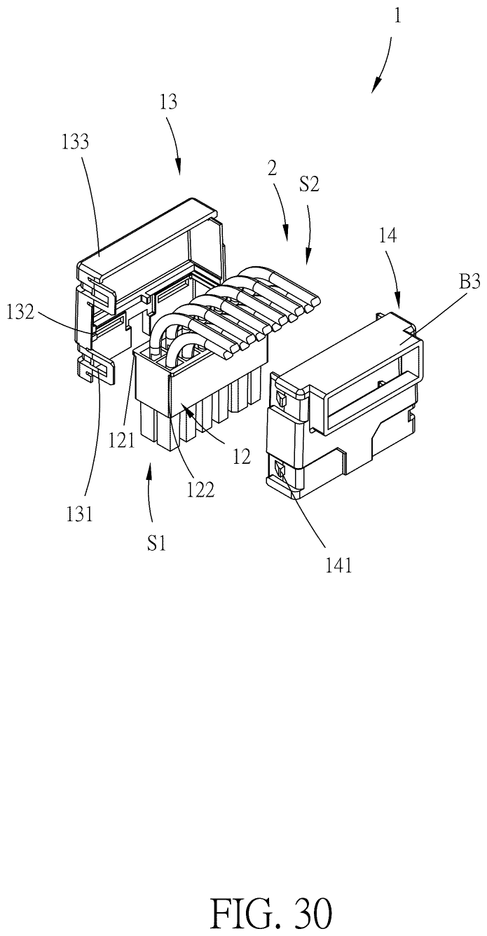

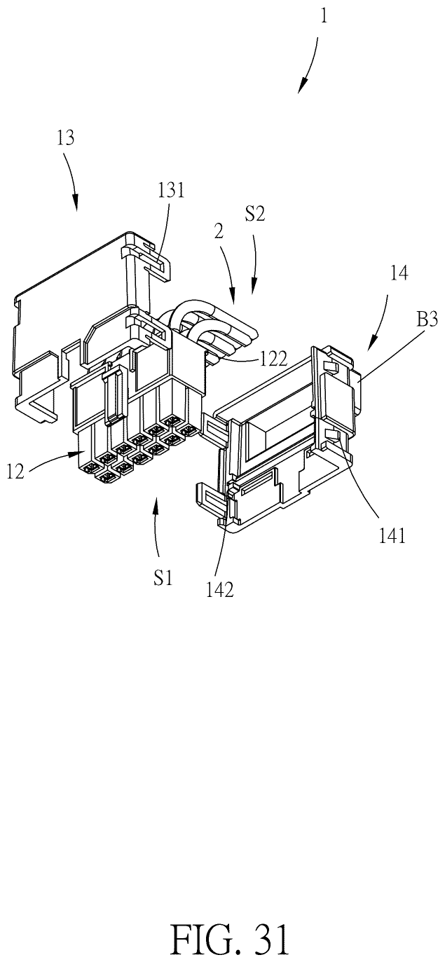

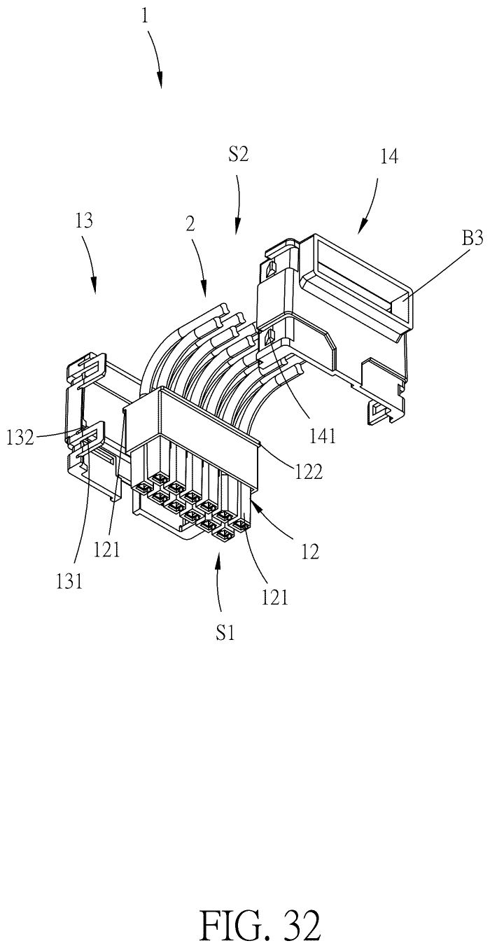

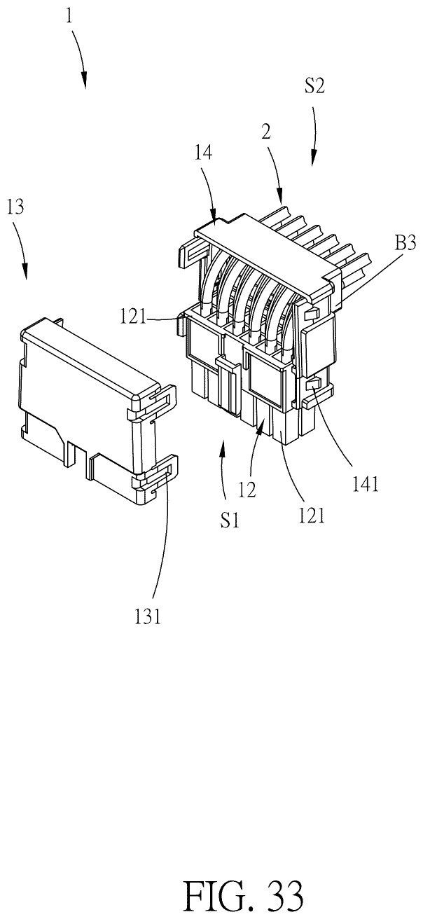

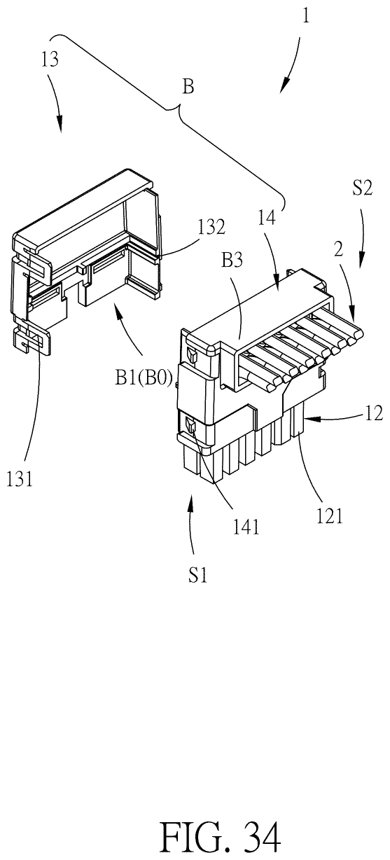

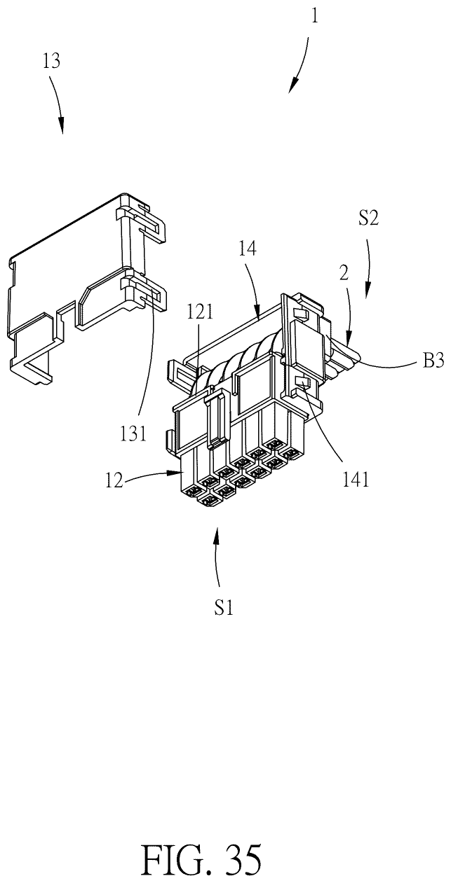

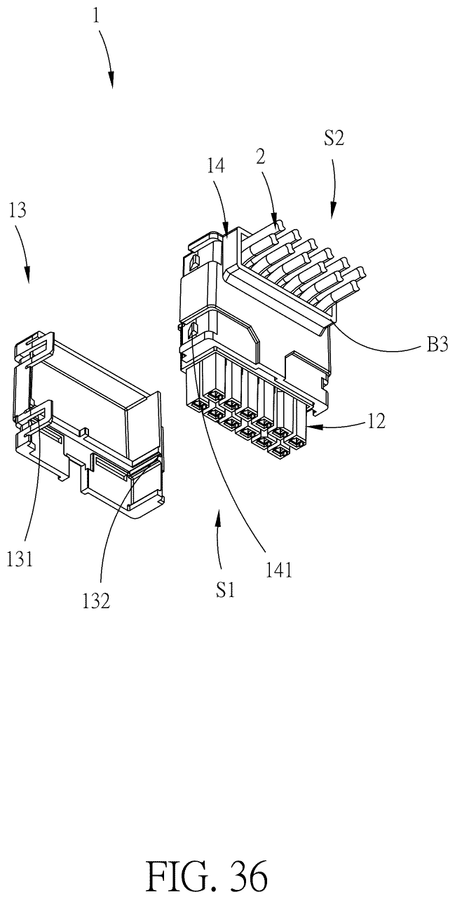

For a detailed description of the embodiments disclosed in the present application, please refer to FIGS. 1 to 36.

In the embodiments shown in FIGS. 1 to 36, at least one cable-end connector 1 and its insulation housing assembly B are disclosed. The cable-end connector 1 can pair with a conductive cable 2 and comprises: a conductive terminal 11, an insulation base 12, a first insulation housing 13, and a second insulation housing 14. The conductive terminal 11 is electrically connected to the conductive cable 2, forming a terminal cable module M with the conductive cable 2 to provide electrical signal transmission.

In the aforementioned embodiments, the insulation base 12 is coupled to the conductive terminal 11, allowing the conductive terminal 11 to extend in a terminal extension direction D1. The insulation base 12 and the terminal cable module M have a first side S1 and a second side S2. Additionally, the first insulation housing 13 comprises a first housing assembly structure 131, and the second insulation housing 14 comprises a second housing assembly structure 141.

In the embodiments shown in FIGS. 1 to 36, the first insulation housing 13 is located on the first side S1, and the second insulation housing 14 is located on the second side S2. The first housing assembly structure 131 is assembled with the second housing assembly structure 141, forming an insulation housing assembly B. Optionally, the first housing assembly structure 131 and the second housing assembly structure 141 can be structurally matched via fastening structures, locking structures, inserting structures, adhesive structures, or welded structures.

It should be noted that in the aforementioned embodiments, the insulation housing assembly B comprises a terminal cable module accommodating space B0, an insulation base accommodating space B1, a conductive cable outlet port B2, and a conductive cable extension guiding structure B3. The terminal cable module accommodating space B0 is provided to house the terminal cable module M, preventing the insulation base 12 from protruding from the insulation housing assembly B. This effectively reduces the size of the cable-end connector 1, enabling the electronic device equipped with the cable-end connector 1 to continue advancing toward being thinner, lighter, and more compact.

Additionally, the insulation base accommodating space B1 is designed to house the insulation base 12, preventing it from protruding from the insulation housing assembly B. This helps reduce the size of the cable-end connector 1, allowing electronic devices equipped with it to continue advancing toward being thinner, lighter, and more compact.

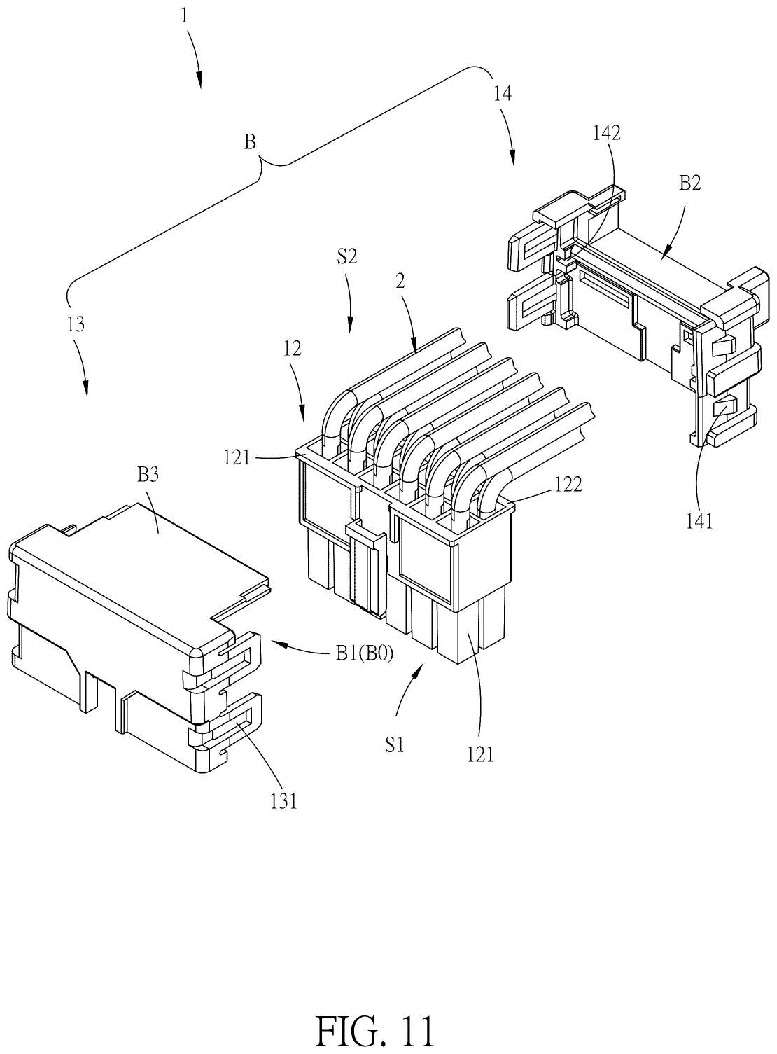

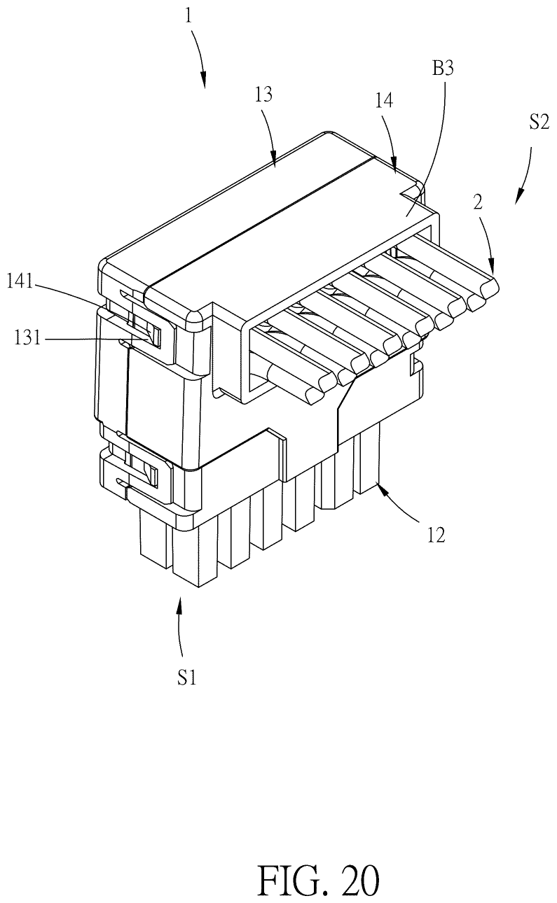

Furthermore, the conductive cable extension guiding structure B3 is located above the conductive cable outlet port B2 to guide the extension of the conductive cable 2. This allows the conductive cable 2 to extend in a cable extension direction D2 toward and out of the conductive cable outlet port B2. The conductive cable extension guiding structure B3 can optionally be a plate-like structure providing a guiding surface (as shown in FIG. 11) and can be positioned on the first insulation housing 13 (as shown in FIG. 11) or the second insulation housing 14 (as shown in FIG. 20). The conductive cable outlet port B2 can optionally be located on the second insulation housing 14.

It should be noted that the cable extension direction D2 is substantially different from the terminal extension direction D1, allowing the extension directions of the conductive cable 2 and the conductive terminal 11 to differ. This ensures that the conductive cable 2 paired with the cable-end connector 1 extends in a manner that meets expectations, making the conductive cable 2 paired with the cable-end connector 1 easier to organize inside electronic devices and preventing unnecessary entanglement. This contributes to the continued development of electronic devices toward being thinner, lighter, and more compact. Optionally, the cable extension direction D2 is substantially perpendicular to the terminal extension direction D1.

Furthermore, in this application, the insulation housing assembly B is formed by assembling the first insulation housing 13 and the second insulation housing 14. By adjusting the structure of the first insulation housing 13 or the second insulation housing 14, the conductive cable outlet port B2 and the conductive cable extension guiding structure B3 can be modified to ensure that the extension of the conductive cable 2 paired with the cable-end connector 1 meets expectations.

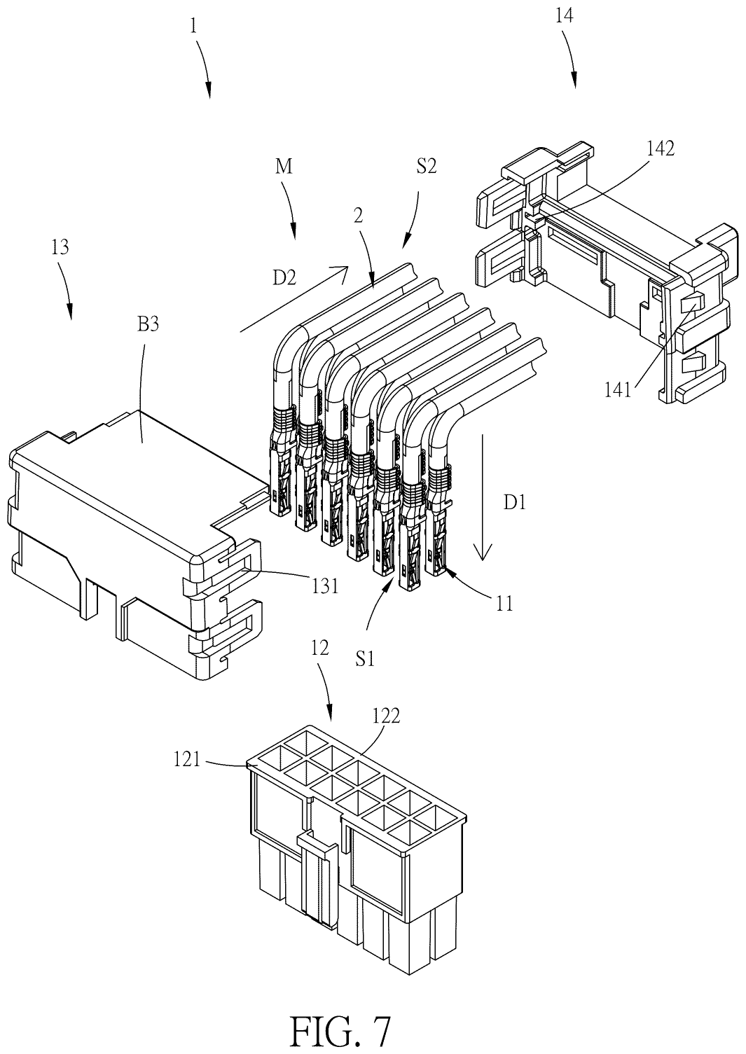

In the embodiments shown in FIGS. 7 to 11, the insulation base 12 comprises a first base positioning structure 121 and a second base positioning structure 122. Correspondingly, the first insulation housing 13 also comprises a first housing positioning structure 132, and the second insulation housing 14 also comprises a second housing positioning structure 142.

It should be noted that the first base positioning structure 121 and the first housing positioning structure 132 form a structurally matching protrusion-and-recess structure, enabling the first base positioning structure 121 to pair with the first housing positioning structure 132 to position the first insulation housing 13 on the insulation base 12, thereby maintaining the positional relationship between the first insulation housing 13 and the insulation base 12. Similarly, the second base positioning structure 122 and the second housing positioning structure 142 form a structurally matching protrusion-and-recess structure, enabling the second base positioning structure 122 to pair with the second housing positioning structure 142 to position the second insulation housing 14 on the insulation base 12, further maintaining the positional relationship between the second insulation housing 14 and the insulation base 12.

It should be noted that in the above embodiments of the cable-end connector provided in this application, certain components can be omitted. For example, in the embodiments of this application, the cable-end connector can comprise only: a conductive terminal, an insulation base, a first insulation housing, and a second insulation housing. The conductive terminal is connected to a conductive cable. The insulation base is coupled to the conductive terminal, allowing the conductive terminal to extend in a terminal extension direction. The insulation base comprises a first side and a second side. The first insulation housing comprises a first housing assembly structure. The second insulation housing comprises a second housing assembly structure. The first insulation housing and the second insulation housing are respectively located on the first side and the second side, and the first housing assembly structure is assembled with the second housing assembly structure to form an insulation housing assembly. The insulation housing assembly comprises an insulation base accommodating space, a conductive cable outlet port, and a conductive cable extension guiding structure. The insulation base accommodating space is provided to house the insulation base. The conductive cable extension guiding structure guides the extension of the conductive cable, allowing the conductive cable to extend in a cable extension direction toward and out of the conductive cable outlet port. The cable extension direction is substantially different from the terminal extension direction.

Additionally, in the embodiments of this application, the insulation housing assembly can comprise only the first insulation housing and the second insulation housing. The first insulation housing comprises a first housing assembly structure. The second insulation housing comprises a second housing assembly structure. The first insulation housing is located on the first side, and the second insulation housing is located on the second side, and the first housing assembly structure is assembled with the second housing assembly structure to form a terminal cable module accommodating space, a conductive cable outlet port, and a conductive cable extension guiding structure. The terminal cable module accommodating space is provided to house the terminal cable module, allowing the conductive terminal to extend in a terminal extension direction. The conductive cable extension guiding structure guides the extension of the conductive cable, allowing the conductive cable to extend in a cable extension direction toward and out of the conductive cable outlet port. The cable extension direction is substantially different from the terminal extension direction.

In summary, this application provides a cable-end connector and insulation housing assembly thereof. The provided cable-end connector pairs with a conductive cable, and the insulation housing assembly can guide the extension of the conductive cable so that the extension direction of the conductive cable meets expectations. This design allows the conductive cable to be easily organized within the electronic device, avoiding unnecessary entanglement and enabling electronic devices to continue evolving toward being thinner, lighter, and more compact. Furthermore, the insulation housing assembly is formed by assembling multiple housings. By adjusting the structures of these multiple assembled housings, the insulation housing assembly can guide the conductive cable to extend in the desired direction.

The examples above are only illustrative to explain principles and effects of the invention, but not to limit the invention. It will be apparent to those skilled in the art that modifications and variations can be made without departing from the spirit and scope of the invention. Therefore, the protection range of the rights of the invention should be as defined by the appended claims.

1. A cable-end connector, the cable-end connector being paired with a conductive cable, the cable-end connector comprising:
a conductive terminal, the conductive terminal being connected to the conductive cable;
an insulation base, the insulation base being mated with the conductive terminal, allowing the conductive terminal to extend in a terminal extension direction, the insulation base comprising a first side and a second side;
a first insulation housing, the first insulation housing comprising a first housing assembly structure; and
a second insulation housing, the second insulation housing comprising a second housing assembly structure; wherein
the first insulation housing is located on the first side, and the second insulation housing is located on the second side, and the first housing assembly structure is assembled with the second housing assembly structure, causing the first insulation housing and the second insulation housing to form an insulation housing assembly, wherein
the insulation housing assembly comprises an insulation base accommodating space, a conductive cable outlet port, and a conductive cable extension guiding structure, the insulation base accommodating space being provided to accommodate the insulation base, the conductive cable extension guiding structure being configured to guide the extension of the conductive cable, allowing the conductive cable to extend in a cable extension direction to the conductive cable outlet port, wherein the cable extension direction is substantially different from the terminal extension direction.

2. The cable-end connector of claim 1, wherein the conductive cable extension guiding structure is installed on the first insulation housing or the second insulation housing.

3. The cable-end connector of claim 1, wherein the conductive cable extension guiding structure is a plate-like structure capable of providing a guiding surface.

4. The cable-end connector of claim 1, wherein the conductive cable outlet port is installed on the second insulation housing.

5. The cable-end connector of claim 1, wherein the insulation base comprises a first base positioning structure and a second base positioning structure, the first insulation housing further comprises a first housing positioning structure, the second insulation housing further comprises a second housing positioning structure, the first base positioning structure being paired with the first housing positioning structure to position the first insulation housing on the insulation base, and the second base positioning structure being paired with the second housing positioning structure to position the second insulation housing on the insulation base.

6. The cable-end connector of claim 5, wherein the first base positioning structure and the first housing positioning structure are structurally compatible protrusion-and-recess structures, and the second base positioning structure and the second housing positioning structure are structurally compatible protrusion-and-recess structures.

7. The cable-end connector of claim 1, wherein the first housing assembly structure and the second housing assembly structure are structurally compatible fastening structures.

8. The cable-end connector of claim 1, wherein the cable extension direction is substantially orthogonal to the terminal extension direction.

9. An insulation housing assembly, the insulation housing assembly being paired with a conductive terminal and a conductive cable, wherein the conductive terminal is connected to the conductive cable, allowing the conductive terminal and the conductive cable to form a terminal cable module, the terminal cable module comprising a first side and a second side; the insulation housing assembly comprising:
a first insulation housing, the first insulation housing comprising a first housing assembly structure; and
a second insulation housing, the second insulation housing comprising a second housing assembly structure; wherein:
the first insulation housing is located on the first side, and the second insulation housing is located on the second side, and the first housing assembly structure is assembled with the second housing assembly structure to form a terminal cable module accommodating space, a conductive cable outlet port, and a conductive cable extension guiding structure, the terminal cable module accommodating space being configured to accommodate the terminal cable module, allowing the conductive terminal to extend in a terminal extension direction, the conductive cable extension guiding structure being configured to guide the extension of the conductive cable, allowing the conductive cable to extend in a cable extension direction to the conductive cable outlet port, wherein the cable extension direction is substantially different from the terminal extension direction.

10. The insulation housing assembly of claim 9, wherein the conductive cable extension guiding structure is installed on the first insulation housing or the second insulation housing.

11. The insulation housing assembly of claim 9, wherein the conductive cable extension guiding structure is a plate-like structure capable of providing a guiding surface.

12. The insulation housing assembly of claim 9, wherein the conductive cable outlet port is installed on the second insulation housing.

13. The insulation housing assembly of claim 9, wherein the first housing assembly structure and the second housing assembly structure are structurally compatible fastening structures.
